(19) United States
(12) Patent Application Publication
(10) Pub. No.: US 2024/0226921 A9
(43) Pub. Date: Jul. 11, 2024

(54) LOW-PROFILE SPRAY DEVICES FOR FIREFIGHTING AND OTHER APPLICATIONS

(71) Applicant: Michael P. Ziaylek, Yardley, PA (US)

(72) Inventors: Michael P. Ziaylek, Yardley, PA (US); Keith R. Creely, Levittown, PA (US); Morgan R. Sobel, Marlton, NJ (US); James Jarozynski, Collingswood, NJ (US)

(21) Appl. No.: 18/488,773

(22) Filed: Oct. 17, 2023

Related U.S. Application Data
(60) Provisional application No. 63/497,981, filed on Apr. 24, 2023.
(60) Provisional application No. 63/379,838, filed on Oct. 17, 2022.

(51) Int. Cl. B05B 1/14; A62C 3/07; B05B 1/20; B05B 15/65

(52) U.S. Cl. CPC B05B 1/14; A62C 3/07; B05B 1/20; B05B 15/65

(57) ABSTRACT

Spray devices are configured to be placed underneath a vehicle, such as an electric vehicle, and to direct water toward the underside of the vehicle. The spray devices can be configured with a low profile, and with spray patterns that minimize water requirements while directing sufficient water at the underside of the vehicle to cool the vehicle battery and prevent, or extinguish battery fires.

### CROSS-REFERENCE TO RELATED APPLICATIONS

This application claims the benefit under 35 U.S.C. § 119(e) to U.S. provisional application No. 63/497,981, filed Apr. 24, 2022, and U.S. provisional application No. 63/379,838, filed Oct. 17, 2022. The contents of these application are incorporated by reference herein in their entirety.

### BACKGROUND

The disclosed technology relates to sprayers, or spray devices, that direct water in a generally upward direction. The spray devices can be used in firefighting operations to extinguish, or prevent fires. The spray devices have a relatively low profile that permits the spray devices to fit under lower suspension vehicles, i.e., vehicles with a low ground clearance. The fire industry currently is facing challenges in relation to electric vehicles (EVs).

When the battery of an EV is compromised, such as immediately after a traffic accident, each cell has the ability to react or heat up, even without the presence of oxygen. The cells can reach temperatures of 1,000 degrees Fahrenheit or greater, and any fire associated with the cells can be very difficult to extinguish. Thus, departments are instructed to apply copious amounts of water on the battery areas from underneath, to attempt to keep the cells cool and limit the chances of thermal run away. This usually requires fire fighters to identify a hot spot, lift the vehicle to access the underneath of the vehicle, and use a water line that provides water at a high flow rate. This protocol can be difficult to follow, since a constant source of high flow-rate water may not be available at the accident site. For example, hydrants and other sources of high flow-rate water often are not readily available on highways and other heavily-traveled roadway on which major motor vehicle accidents frequently occur. In such cases, the firefighting team needs to transport substantial amounts of water to the accident scene using, for example, tanker trucks.

### SUMMARY

In one aspect of the disclosed technology, a spray device includes a tubular body defining an interior volume. The body has a plurality of holes formed therein and adjoining the interior volume. The holes are located along not more than an upper half of the body. The device also includes at least one foot connected to the body and configured to maintain the body in an upright orientation; and a coupling mounted on an upstream end of the body and in fluid communication with the interior volume of the body. The coupling is configured to be fluidly coupled to a source of water. The body is configured so that the water supplied to the body by way of the coupling can exit the spray device by way of the holes in an upward and outward direction.

In another aspect of the disclosed technology, the body is a first body, the spray device further includes a second body, and the second body is configured to be connected to, and fluidly coupled to the first body to increase an overall length of the spray device.

In another aspect of the disclosed technology, the coupling is a first coupling, the spray device further includes a second coupling, and the second coupling is configured to mechanically connect the first body to the second body.

In another aspect of the disclosed technology, a downstream end of the body is sealed.

In another aspect of the disclosed technology, the downstream end of the body is flattened.

In another aspect of the disclosed technology, the spray device further includes a resilient material located within the downstream end of the body. The resilient material is configured to be compressed by the downstream end of the body to thereby seal the downstream end of the body.

In another aspect of the disclosed technology, the spray device further includes an end cap configured to be positioned on the downstream end of the body to thereby seal the downstream end of the body.

In another aspect of the disclosed technology, a maximum height of the spray device is no greater than about 5.5 inches.

In another aspect of the disclosed technology, the maximum height of the spray device is no greater than about 4.0 inches.

In another aspect of the disclosed technology, the maximum height of the spray device is no greater than about 3.0 inches.

In another aspect of the disclosed technology, the maximum height of the spray device is no greater than about 2.0 inches.

In another aspect of the disclosed technology, the spray device has a length of about 37 inches.

In another aspect of the disclosed technology, each of the holes has a diameter of about 1/16-inch.

In another aspect of the disclosed technology, the body has an inside diameter of about 1.5 inch.

In another aspect of the disclosed technology, the at least one foot has a substantially V-shaped configuration.

In another aspect of the disclosed technology, the body is rigid.

In another aspect of the disclosed technology, a method of spraying water on an underside of a vehicle includes providing a spray device. The spray device has a tubular body defining an interior volume. The body has a plurality of holes formed therein and adjoining the interior volume. The holes are located along not more than an upper half of the body. The spray device also includes at least one foot connected to the body and configured to maintain the body in an upright orientation, and a coupling mounted on an upstream end of the body and in fluid communication with the interior volume of the body. The method also includes placing the spray device underneath the vehicle, and fluidly coupling the coupling to a source of water so that the water supplied to the body by way of the coupling can exit the spray device by way of the holes in an upward and outward direction toward the underside of the vehicle.

In another aspect of the disclosed technology, placing the spray device underneath the vehicle includes placing the spray device underneath the vehicle so that the at least one foot rests on the ground at least some of the holes in the body face the underside of the vehicle.

In another aspect of the disclosed technology, the body is a first body and the coupling is a first coupling, and the method further includes mechanically connecting the first body to the second body by way of the second coupling.

In another aspect of the disclosed technology, the spray device includes a base, a plate member mounted on the base, a coupling configured to be fluidly coupled to a source of water, and a membrane retained by the plate member and the base. The membrane has an upwardly-facing, dome-shaped portion having a plurality of holes formed therein. The membrane and the base define an interior volume in fluid communication with the coupling and the holes so that the water supplied to the coupling can exit the spray device by way of the holes in an upward and outward direction.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

FIG. 1 is a perspective, cross-sectional view of a spray device for use in firefighting and other operations, taken through the line A-A of FIG. 3;

FIG. 2 is an exploded view of the spray device shown in FIG. 1;

FIG. 3 is top view of the spray device shown in FIGS. 1 and 2;

FIG. 4 is a side cross-sectional view of the spray device shown in FIGS. 1-3, taken trough the line “A-A” of FIG. 3;

FIG. 5 is a magnified view of the area designated “B” in FIG. 4;

FIG. 6 is a side cross-sectional view of the spray device shown in FIGS. 1-5, taken trough the line “C-C” of FIG. 3;

FIG. 7 is a side view of the spray device shown in FIGS. 1-6, depicting the spray device positioned underneath an electric vehicle;

FIG. 8 is a side view of another spray device for use in firefighting and other operations;

FIG. 9 is a front, or upstream view of the spray device shown in FIG. 8;

FIG. 10 is a cross-sectional view of the spray device shown in FIGS. 8 and 9, taken through the line “D-D” of FIG. 8;

FIG. 11 is a front view of the spray device shown in FIGS. 8-10, depicting the spray device positioned underneath the electric vehicle;

FIG. 12 is an exploded perspective view of another the spray device for use in firefighting and other operations, depicting the spray device in a single-body configuration;

FIG. 13 is a cross-sectional view of the spray device shown in FIG. 12, taken through the line “E-E” of FIG. 12;

FIG. 14 is a perspective view of the spray device of in FIGS. 12 and 13, depicting the spray device in a two-body configuration;

FIG. 15 is a side view of the spray device in the single-body configuration shown in FIGS. 12 and 13, positioned underneath the electric vehicle;

FIG. 16 is a side view of the spray device in the double-body configuration shown in FIG. 14, positioned underneath the electric vehicle;

FIG. 17 is a perspective view of another spray device for use in firefighting and other operations, depicting the spray device in a two-body configuration;

FIG. 18 is a magnified view of the area designated “F” in FIG. 17, depicting the bodies of the spray device in an uncoupled state;

FIG. 19 is a top view of the spray device shown in FIGS. 17 and 18, depicting the spray device in a single-body configuration;

FIGS. 19A and 19B are top-perspective exploded views of the spray device shown FIGS. 17-19, depicting the spray device in the single-body configuration;

FIG. 20 is a top view of the spray device shown in FIGS. 17-19, depicting the spray device in the two-body configuration;

FIG. 21 is a front, or upstream view of the spray device shown in FIGS. 17-20;

FIG. 22 is a magnified perspective view of the area designated “G” in FIG. 17;

FIG. 23 is a magnified side view of the area designated “G” in FIG. 17;

FIG. 24 is a side view of the spray device shown in FIGS. 17-23, depicting the spray device in the two-body configuration and positioned underneath the electric vehicle;

FIG. 25 is a bottom view of the spray device shown in FIGS. 17-24, depicting the spray device in the two-body configuration and positioned underneath the electric vehicle in an orientation offset by about 90 degrees from the orientation shown in FIG. 24;

FIG. 26 is a bottom view of the spray device shown in FIGS. 17-25, depicting the spray device in the single-body configuration and positioned underneath the electric vehicle in the orientation shown in FIG. 25;

FIG. 27 is a bottom view of the spray device shown in FIGS. 17-26, depicting the spray device in the two-body configuration and positioned underneath the electric vehicle in the orientation shown in FIG. 24;

FIG. 28 is a tabular representation of flow rates and pressures for the spray device shown in FIGS. 17-27, in the single-body and double-body configurations shown respectively in FIGS. 19 and 17;

FIG. 29 is an exploded perspective view of an extension device configured for use with the spray devices shown in FIGS. 8-27 and equipped with a quick-connect coupling;

FIG. 30 is an exploded perspective view of the extension device shown in FIG. 29, equipped with a double-female swivel coupling;

FIG. 31A is a top view of an alternative embodiment of the spray device shown in FIGS. 1-6;

FIG. 31B is a side view of the spray device shown in FIG. 31A;

FIG. 31C is a side view of the spray device shown in FIGS. 31A and 31B, from a perspective offset by about 90 degrees from the perspective of FIG. 31B;

FIG. 31D is a top-perspective exploded view of the spray device shown in FIGS. 31A-31C; and

FIG. 31E is a bottom-perspective exploded view of the spray device shown in FIGS. 31A-31D.

### DETAILED DESCRIPTION

The spray devices disclosed herein can be configured, for example, to help keep the battery of an EV cool following a traffic accident while firefighters and other first responders tend to other issues such a rescuing the injured, diverting traffic around the accident scene, etc. The specific spray patterns, overall low profile, and low flow rate of the spray devices, and the ability to adapt multiple devices together can provide firefighters and other first responders with the ability to cool EV batteries and prevent battery fires at locations where a high flow-rate of pressurized water may not be available.

As a non-limiting example, the spray devices can be placed under an electric vehicle (EV) experiencing an actual or potential battery fire. EV's generally have a relatively low ground clearance, e.g., 5.5 inches, and the batteries of EVs typically are located along the bottom or underside of the EV. Thus, in the event or an actual or potential battery file, water needs to be directed at the underside of EV, and onto the relatively large surface area of the battery. The upwardly-directed water flow from the low-profile spray devices disclosed herein can impinge upon, and wet the underside of the EV to extinguish a battery or other type of fire, and/or to cool the battery to prevent the occurrence or reignition of a battery fire.

It is believed that the spray devices can reduce, by up to thousands of gallons, the amount of water needed to extinguish a battery fire and/or to cool the damaged battery of an electric vehicle. In most situations involving battery fires in EVs following traffic accidents, the large amount of water needed to extinguish the battery fire and to cool the battery to prevent reignition is not available at the scene of the accident, because a typical fire engine does not have the capacity to hold such large amounts of water. The spray devices disclosed herein can help address this problem by allowing the firefighters or other first responders to direct a relatively limited supply of water directly onto the battery, where it is needed.

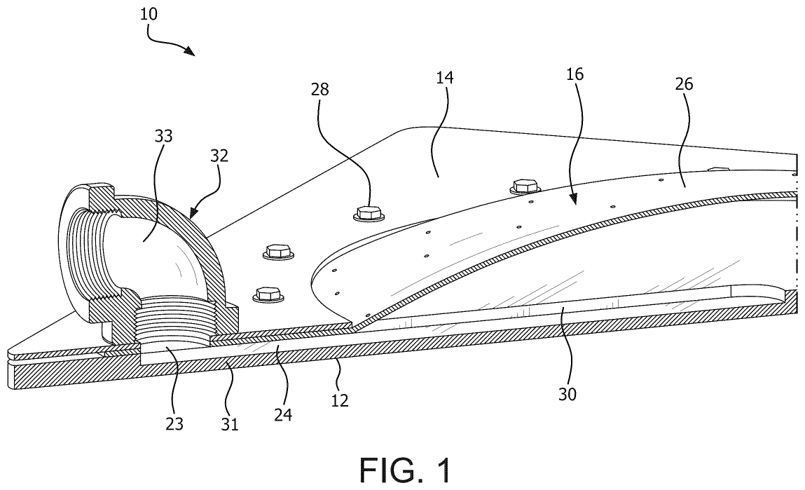

FIGS. 1-7 depict an embodiment in the form of a spray device 10. The spray device 10 includes a base 12, a sheet member 14, and an expandable membrane 16. The base 12 is substantially flat, and forms the bottom of the device 10. The base 12 is configured to rest on the ground or other supporting surface. The base 12 can be formed from a durable, heat-resistant, rigid or semi-rigid material such as high impact resistant plastic, aluminum, etc. An upwardly-facing channel 20 is formed in the base 12. The channel 20 is visible in FIGS. 1, 2, and 5.

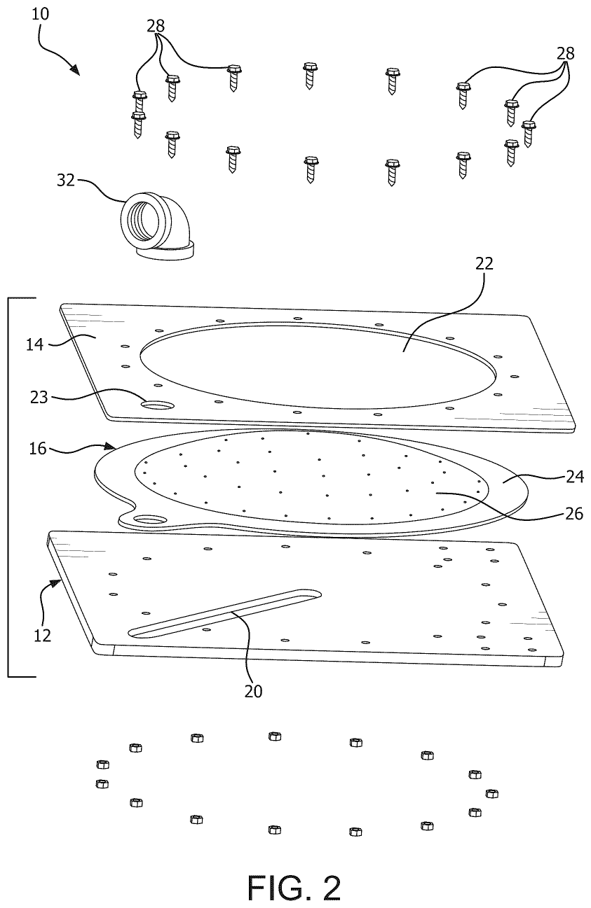

The sheet member 14 is substantially flat, and can be formed from a durable, heat-resistant, rigid or semi-rigid material such as aluminum or stainless steel. The sheet member 14 has a circular opening 22 formed therein, as shown in FIG. 2. The sheet member 14 also has a small circular opening 23 formed therein, proximate a corner of the sheet member 14, as also shown in FIG. 2.

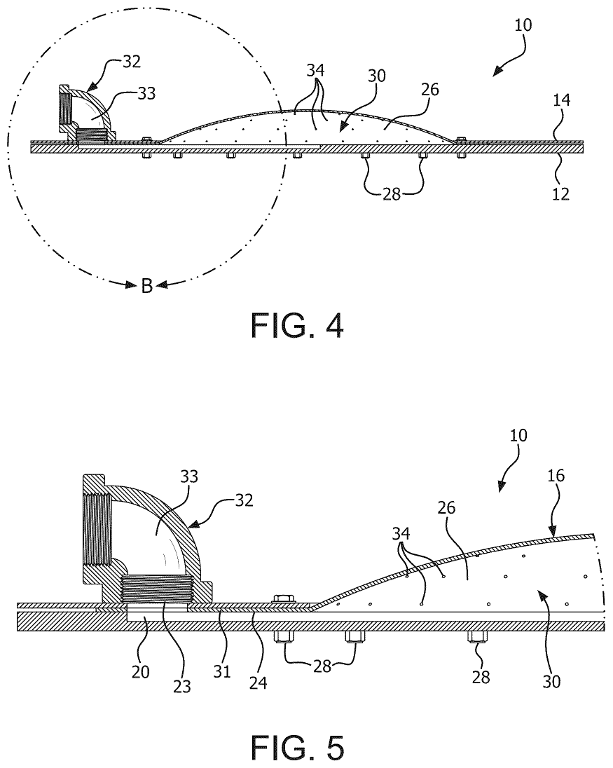

The membrane 16 is formed from an elastic and heat-resistant material such as natural or synthetic rubber, or vinyl. Referring to FIG. 2, the membrane 16 has a generally ring-shaped outer portion 24, and an inner portion 26 that adjoins the outer portion 24. The outer circumference of the inner portion 26 is circular, and adjoins the inner circumference of the outer portion 24. The inner portion 26 has a three-dimensional curvilinear shape, and extends upwardly between its outer circumference and its center point, giving the inner portion 26 arc or dome-like configuration as can be seen in FIGS. 4-6.

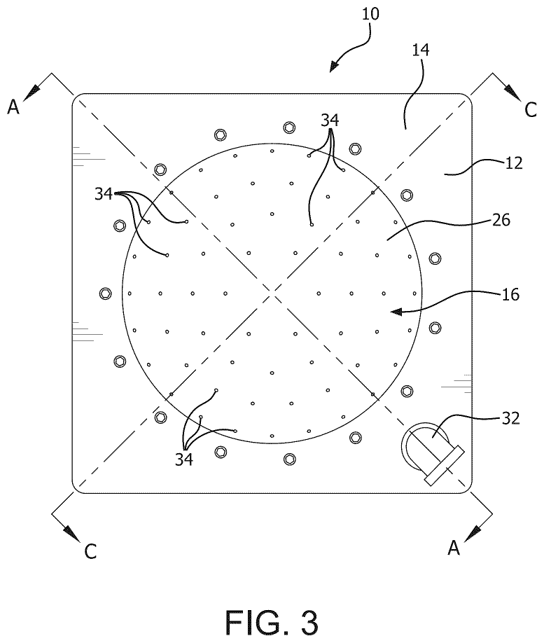

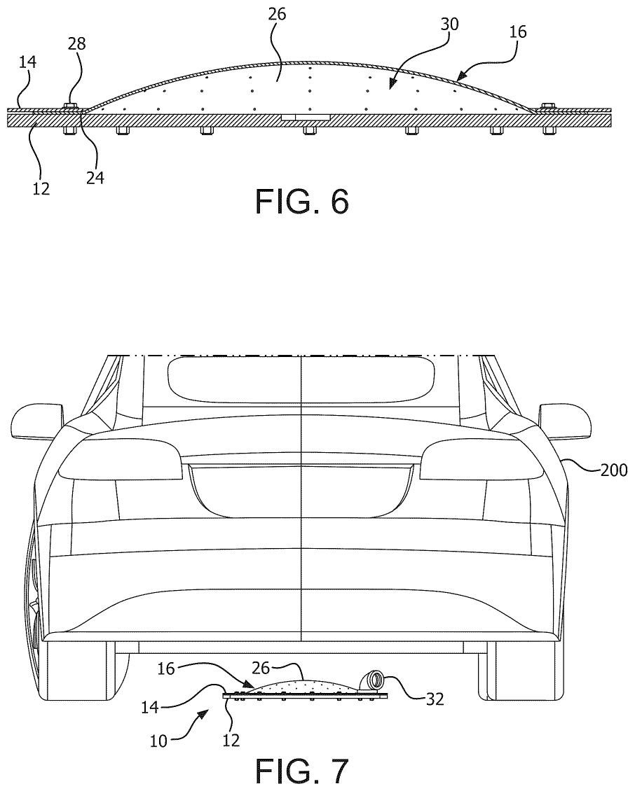

The sheet member 14 and the membrane 16 are secured to the base 12. In particular, the plate member 14 is secured to the base 12 by a suitable means such as fasteners 28 that extend through the plate member 14 proximate the outer circumference of the opening 22 in the sheet member 14, as shown in FIGS. 2 and 3. The diameter of the opening 22 is about equal to the diameter of the inner portion 26 of the membrane 16, so that the inner portion 26 extends through, and above the opening 22, as can be seen in FIG. 6. The outer diameter of the outer portion 24 of the membrane 16 is greater than the diameter of the opening 22, so that the outer portion 24 is sandwiched between, compressed, and held in place by the plate member 14 and the base 12, as also can be seen in FIG. 6. The fasteners 28 help to establish a watertight seal between the outer portion 24 and the underlying surface of the base 12.

The inner portion 26 of the membrane 16 and the underlying surface of the base 12 form an interior volume 30 of the spray device 10. The interior volume 30 is visible in FIGS. 1 and 4-6. The outer portion 24 of the membrane 16 and an overlying portion of the plate member 14 cover the channel 20 in the base 12. The channel 20 and the overlying section of the membrane 16 define a passage 31 that adjoins the interior volume 30. The passage 31 is visible in FIGS. 1 and 5. The channel 20, and the passage 31 defined thereby, are sized to accommodate the specific ranges of pressure and flow rate of the water that will be supplied to the spray device 10.

The spray device 10 further includes a pipe member or fitting 32. The fitting 32 is securely mounted on an upper surface of the plate member 14. The fitting 32 is configured as a 90-degree elbow, allowing the fitting 32 to be accessed from the side and helping to provide the spray device 10 with a low profile. The fitting 32 and has an internal passage 33 in fluid communication with the passage 31 defined by the membrane 16 and the base 12, as can be seen in FIGS. 1 and 5.

The exit of the internal passage 33 aligns with the opening 23 in plate member 14, so that fluid can pass through the hole 23 upon exiting the internal passage 33 and entering the passage 31. The fitting 32 is configured with threads or other suitable means for engaging a coupling or adapter on a hose or other type of water supply. Thus, water can be supplied to the interior volume 30 of the spray device 10 by way of the fitting 32 and the passage 31.

The membrane 16 has a plurality of small openings or holes 34 formed therein. The holes 32 have a circular shape; the holes 32 can have other shapes in alternative embodiments. During operation of the spray device 10, pressurized water is supplied to the spray device 10 from a hose or other means coupled to the fitting 32. The pressurized water flows through the passage 31, and into the interior volume 30. The membrane 16 can expand in response to the pressurization of the internal volume 30, without bursting or otherwise becoming compromised. For example, the membrane 30 can be configured to withstand the water pressures of about 20 psi to about 150 psi typically provided by fire engines.

The low profile to the spray device 10 allows the spray device 10 to be placed directly beneath a low ground clearance vehicle 200, such an EV with a ground clearance of about 5.5 inches, as shown in FIG. 7. For example, the maximum height of the membrane 16 above the ground is about 2.9 inches; and the maximum height of the fitting 32 above the ground is about 4.4 inches. These dimensions are presented for illustrative purposes only, and these dimensions can differ from the noted values in alternative embodiments.

Once the spray device 10 is positioned under the vehicle 200 with the water supply hose connected to the fitting 32, pressurized water can be supplied to the spray device 10 by a fire engine or other source. The spray device 10 is depicted in FIG. 7 without a hose or water supply attached thereto, for clarity of illustration. As noted above, the pressurized water enters the spray device 10 by way of the fitting 32, and flows from the fitting 32 and to the interior volume 30 by way of the passage 31.

The pressurized water exits the interior volume 30 by way of the holes 34. As a result of the domed shape of the inner portion 26 of the membrane 16, the water exiting the holes 34 travels both upward and outward, i.e., in a direction of travel with both a vertical component and a horizontal component. Thus, when the spray device 10 is placed beneath a vehicle 200 such as an EV, and is supplied with pressurized water, the spray device 10 will direct a multitude of relatively small streams of water over a relatively large surface area of the overlying battery of the EV. Due to the angled trajectories of the water steams, and the distribution of the holes 34 throughout the inner portion 26 of the membrane 16, the water impinges on, and wets a relatively large area on the bottom surface of the battery. For example, the spray device 10 can be configured to direct water onto a circular area having a diameter of about 21 inches, and located about 5.5 inches above the ground. These values are presented for illustrative purposes only; the shape and size of the surface area wetted by the spray device 10 can differ from these values in alternative embodiments.

Thus, the spray device 10 can distribute a relatively small amount of water over a relatively large area, in a manner in which substantially all of the water exiting the spray device is directed to a location at which it is needed. This helps to maximize the efficiency and efficacy with which the water supply is used extinguish a battery fire and/or cool the battery. By contrast, it can be difficult for a firefighter, using a hose, to direct a water stream at the underside of a low ground clearance vehicle 200 in a manner in which all, or most of the water reaches the downwardly-facing surfaces in need of wetting.

The holes 34 can be of the same size, to help ensure that the water flow from each hole 34 is consistent. The optimum size, number, and relative locations of the holes 34, and the curvature of the inner portion 26 of the membrane are application-dependent, and can vary with factors such as the size, shape, and density of the spray pattern needed for a particular application, the pressure or range of pressures of the water that will be supplied to the spray device 10, the degree to which the holes will expand as the interior volume 30 is pressurized, etc. For example, the holes 34 can have a diameter of abut 1/16 inch.

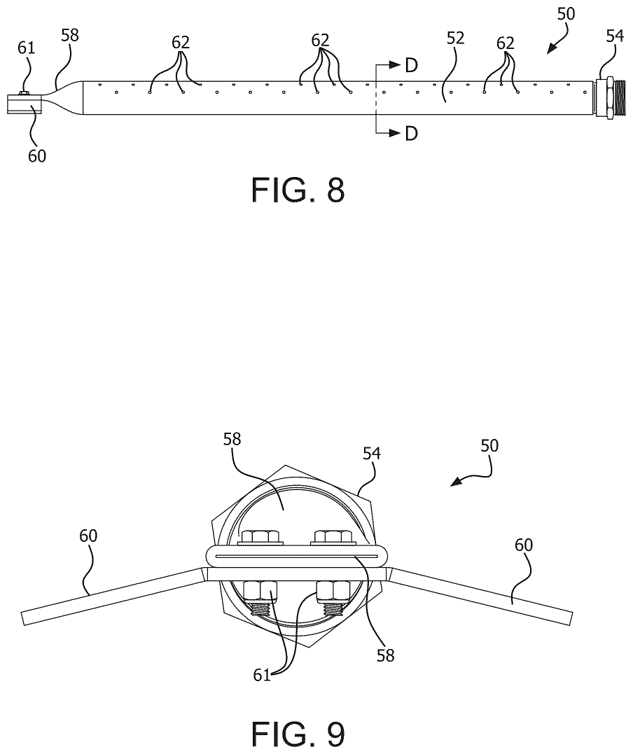

FIGS. 8-11 depict another embodiment in the form of a spray device 50. The spray device 50 has a generally tubular configuration. Also, the spray device 50 has a relatively low profile that allows the spray device 50 to fit under a vehicle 200 having a low ground clearance, such as an EV with a ground clearance of about 5.5 inches. For example, the spray device 50 can have a maximum height above the ground of about 2.5 inches to about 3.0 inches, and a length of about 37 inches. These specific values are presented for illustrative purposes only; alternative embodiments can have a maximum height and a length other the noted values.

The spray device 50 incudes a generally tubular body 52, and a coupling 54 fixed to a first end of the body 52 by threads or other suitable means. The body 52 has an interior volume 51, and can be formed from a durable, rigid, and heat-resistant material such as aluminum. The body 52 can have an outer diameter of about 1.5 inches. A specific value for the outer diameter of body 52 is specified for illustrative purposes only; the outer diameter of the body 52 can have other values in alternative embodiments.

The coupling 54 is configured to engage a coupling or adapter on a hose or other type of water supply. The coupling 54 can be, for example, a 1½ inch NPT to NST adapter configured to engage threads on the first end of the body 52. This particular type of coupling 54 is disclosed for illustrative purposes only. The coupling 54 can have other configurations in alternative embodiments. In other alternative embodiments, the body 52 can be configured to be connected directly to the hose or other type of water supply without the coupling 54.

A second or downstream end 56 of the body 52 can be flattened, as shown in FIGS. 8 and 9. A gasket 58 in the form of, for example, a piece of rubber material, is positioned within the flattened end 56 to form a water tight seal. In alternative embodiments, a flattened end cap can be fixed to the body 52 in lieu of flattening the end 56. An upstream end of the end cap can have a circular cross section, to match the cross section of the body 52. A downstream end of the end cap can be flattened, with the gasket 58 being positioned within the flattened portion of the end cap 56.

The spray device 50 also includes feet 60 that are attached to the flattened end 56, by a suitable means such as fasteners 61. In addition to securing the feet 60 to the end 56, the fasteners help to compress the flattened portion of the end 56 onto the gasket 58. The feet 60 are configured to stabilize the spray device 50, and to help the spray device 50 to remain in an upright position (shown in FIGS. 8-11) when placed on the ground. The feet 60 also can help to prevent the spray device 50 from “walking” or otherwise moving out of place once it has been positioned, for example, under a vehicle such as the vehicle 200. The feet 60 can be mounted on the body 52 in alternative embodiments.

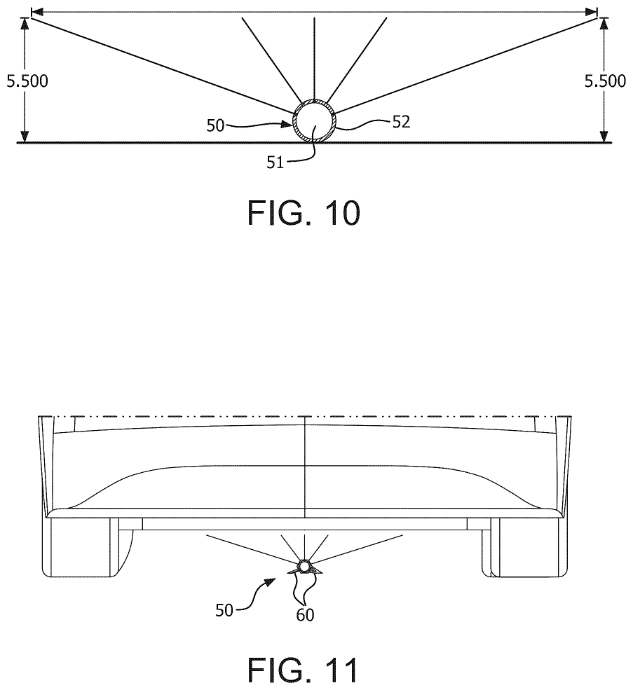

Pressurized water can be directed to an interior volume 51 of the body 52 by way of the coupling 54. The interior volume is depicted in FIG. 10. A plurality of small holes 62 are formed in the upper half of the body 50, as shown in FIG. 8. The holes 62 have a circular shape; the holes 62 can have other shapes in alternative embodiments. The pressurized water within the interior volume 51 exits the body 52 by way of the holes 62, and is directed upwardly and outwardly by the holes 62. For example, the body 52 can include about 75 to about 155 of the holes 62. The holes 62 can be located at radial positions on the body 52 spanning a range of about 120 degrees to about 150 degrees, i.e., the holes 62 can be radially offset from the top-center of the body 52 in each of the clockwise and counter-clockwise directions by about 60 degrees to about 75 degrees. The preceding values for the number and locations of the holes 62 are presented for exemplary purpose only. The optimum size, number, and relative locations of the holes 62 are application-dependent, and can vary with factors such as the size, shape, and density of the spray pattern needed for a particular application; the pressure or range or pressure of the water that will be supplied to the spray device 50; the need or desire to maintain consistent flow through each hole 62 along the length of the body 52; etc. For example, the holes 62 can have a diameter of about 1/16 inch.

The low profile to the spray device 50 allows the spray device 50 to be placed directly beneath a low ground clearance vehicle 200, such an EV with a ground clearance of about 5.5 inches, as depicted in FIG. 11. The spray device 50 is depicted in FIG. 11 without a hose or water supply attached thereto, for clarity of illustration. As noted above as a non-limiting example, the spray device 50 can have a maximum height above the ground of about 2.5 to 3.0 inches.

Once the spray device 50 is positioned under the vehicle 200 with the water supply hose connected to the coupling 54, pressurized water can be supplied to the spray device 50 by a fire engine or other source. The pressurized water enters the spray device 50 by way of the coupling 54, and flows from the coupling 54 and to the interior volume 51 of the body 52.

The pressurized water exits the interior volume 51 by way of the holes 62. As a result of the curved shape of the body 52 and the location on the holes 62 on the upper half of the body 52, the water exiting the holes 62 travels both upward and outward, i.e., in a direction of travel with both a vertical component and a horizontal component, as can be seen in FIGS. 10 and 11. Thus, when the spray device 50 is placed beneath a vehicle, such as the vehicle 200, and is supplied with pressurized water, the spring device 50 will direct a multitude of relatively small streams of water over a relatively large surface area of the overlying battery of the EV. Due to the angled trajectories of the water steams, the water impinges on, and wets a relatively large area on the bottom surface of the battery. For example, the spray device 10 can be configured to direct water directly onto a surface area about 36 inches long and about 25 inches wide, and located about 5.5 inches above the ground. If unobstructed, the water will travel up to a surface area of about four feet wide by about eight feet long. The preceding values are presented for illustrative purposes only; the shape and size of the surface area wetted by the spray device 50 can differ from these values in alternative embodiments.

Thus, the spray device 50 can distribute a relatively small amount of water over a relatively large area, in a manner in which substantially all of the water exiting the spray device 50 is directed to a location at which it is needed. This helps to maximize the efficiency and efficacy with which the water supply is used extinguish a battery fire and/or cool the battery. By contrast, as noted above, it can be difficult for a firefighter, using a hose, to direct a water stream at the underside of a low ground clearance vehicle, such as the vehicle 200, in a manner in which all, or most of the water reaches the downwardly-facing surfaces in need of being wetted.

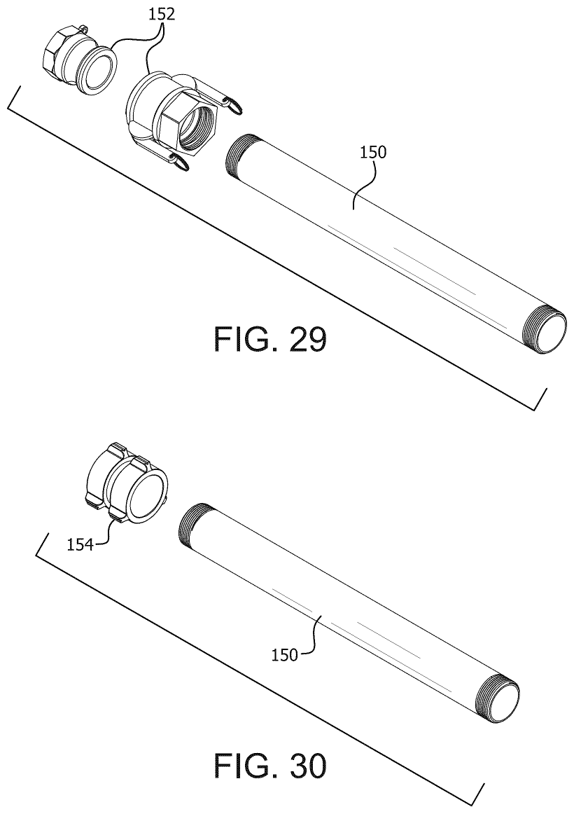

The overall length of the spray device 50 can be increased by adding one or more tubular extension members (not shown). The extension member is similar to the body 52, with the exception that the extension member does not have the flattened end 56. A first or downstream end of the extension member can be joined to the first or upstream end of the body 52 by a suitable coupling connected to the body 52 in lieu of the coupling 54. A second or upstream end of the extension member can be connected to the hose or other type of water supply by a coupling 54 installed on the second end of the extension member. Alternative embodiments of the extension member can be formed without any spray holes, as shown in FIGS. 29 and 30 and discussed below.

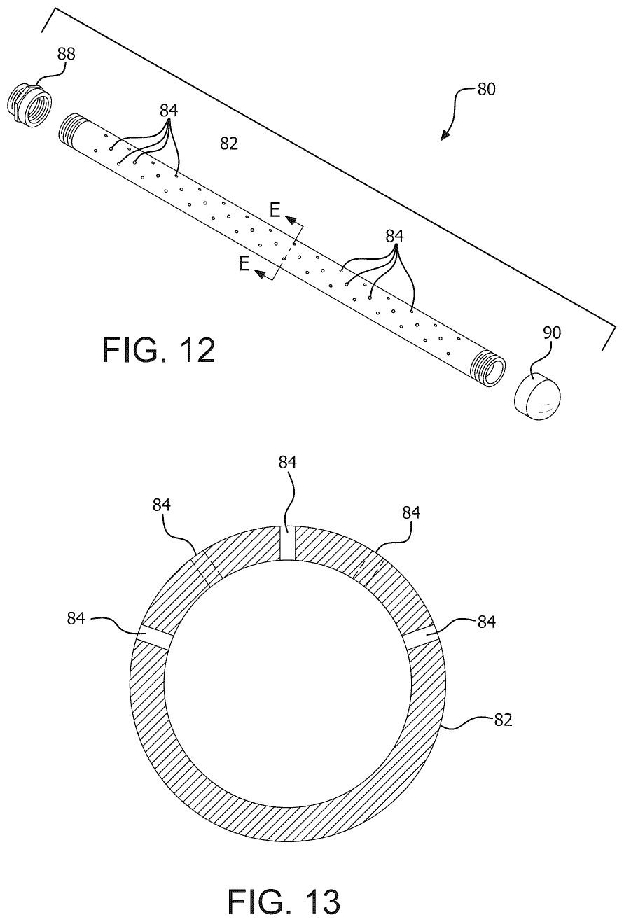

FIGS. 12-16 depict another embodiment in the form of a spray device 80. The spray device 80 has a generally tubular configuration. The spray device 80 is similar to the spray device 50, with the exception that the spray device 80 does not include the flattened end 56 or the feet 60 of the spray device 50. The above description and discussion of the spray device 50 otherwise applies equally to the spray device 80, unless otherwise indicated below.

The spray device 80 incudes a body 82 having a plurality of holes 84 formed therein as described above in relation to the body 52 of the spray device 50. The body 82 can be formed from a durable, rigid, and heat-resistant material such as aluminum or PVC. For example, the body 82 can be formed from 1.5-inch diameter PVC with a total of 78 number 43 holes formed therein. This particular configuration for the body 82 is disclosed for illustrative purposes only. The body 82 can have other configurations in alternative embodiments.

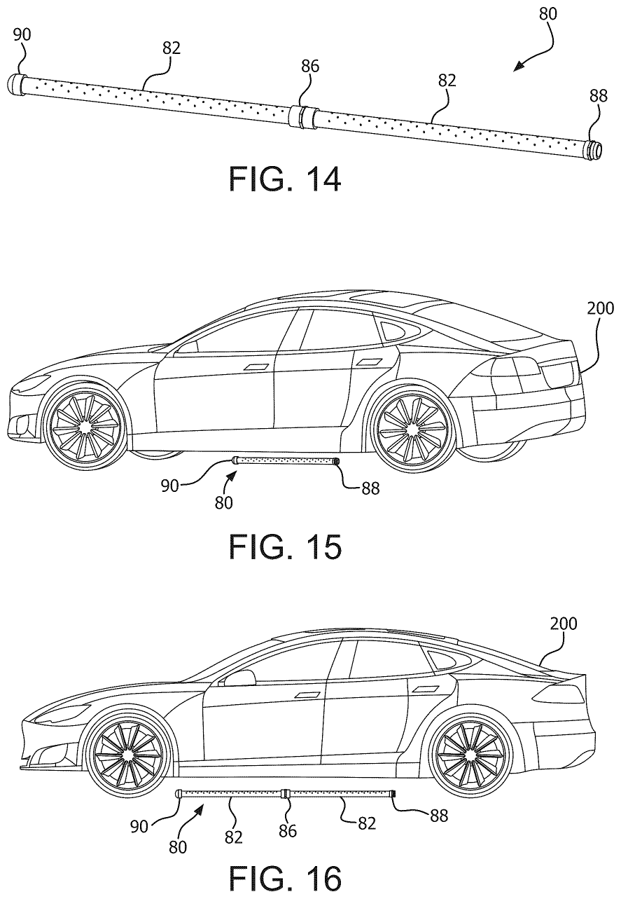

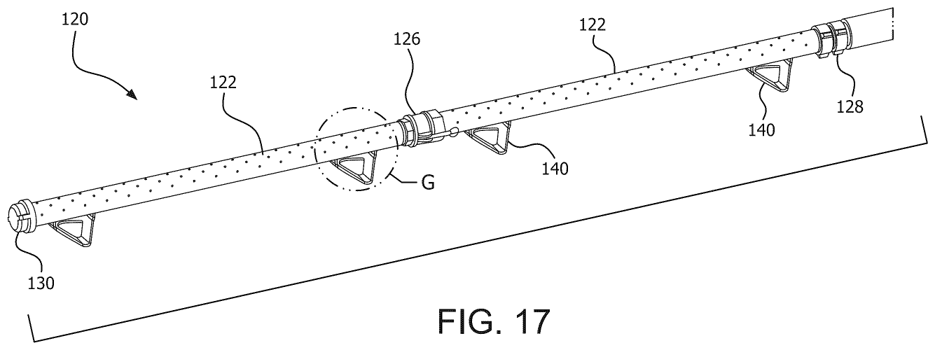

Two or more of the bodies 82 can be connected together to make the overall length of the spray device 80 suitable for a specific application, as shown in FIGS. 14 and 16. In the example shown in the figures, two the of the bodies 82 are connected by way of a coupling 86 that engages threads formed on the ends of the bodies 82. The coupling 86 can be, for example, a double swivel female coupling. This particular type of coupling 86 is disclosed for illustrative purposes only. The coupling 86 can have other configurations in alternative embodiments.

An upstream end of one of the bodies 82 is connected to a coupling or adapter on a hose or other source of water by a coupling 88 that engages threads on the upstream end of the body 82. The coupling 88 can be, for example, a 1.5-inch female NPT to 1.5-inch male NH/NST adapter. This particular type of coupling 88 is disclosed for illustrative purposes only. The coupling 88 can have other configurations in alternative embodiments. The downstream end of the downstream body 82 is capped and sealed by a cap 90 that engages threads on the downstream end of the body 52.

The body 82 can be equipped with a stabilizing foot (not shown) that helps to balance the spray device 80 in an upright position, and inhibits the spray device 80 from “walking” or otherwise moving out of place once it has been positioned, for example, under a vehicle such as the vehicle 200. Alternative embodiments can be equipped with feet having a ski-like shape that can allow the spray device 80 to slide over cracks and small obstructions.

The spray device 80 can be placed under the low ground clearance vehicle 200, as shown in FIGS. 15 and 16, and can be used in a manner similar to the spray device 50 to direct and disperse water at the underside of the vehicle 200 as discussed above in relation to the spray device 50. The spray device 80 is depicted in FIGS. 15 and 16 without a hose or water supply attached thereto, for clarity of illustration.

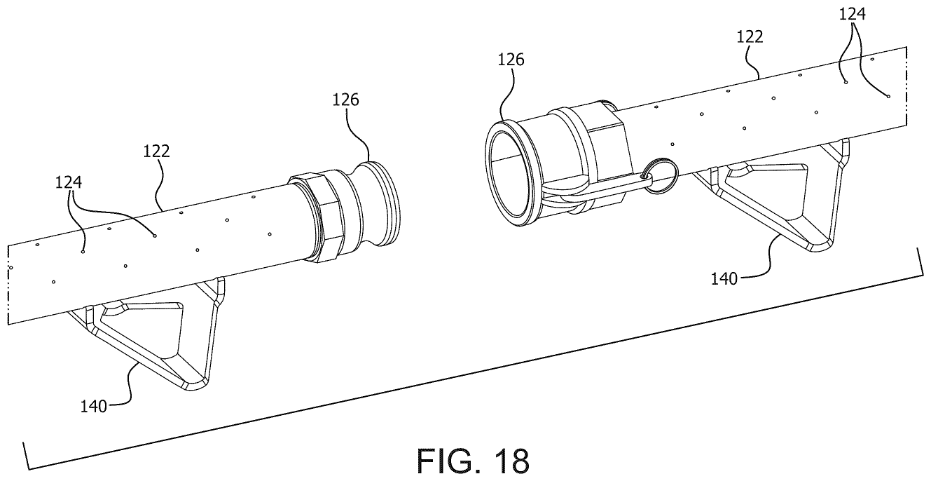

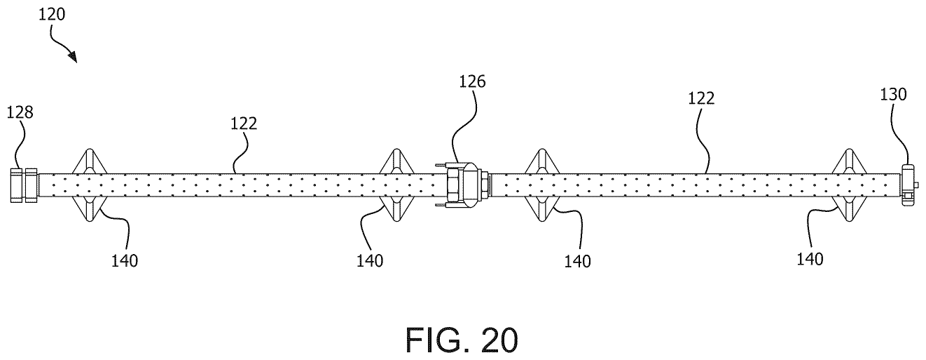

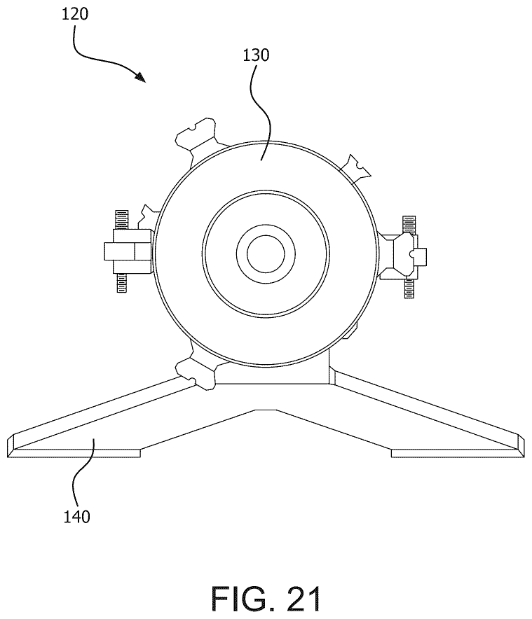

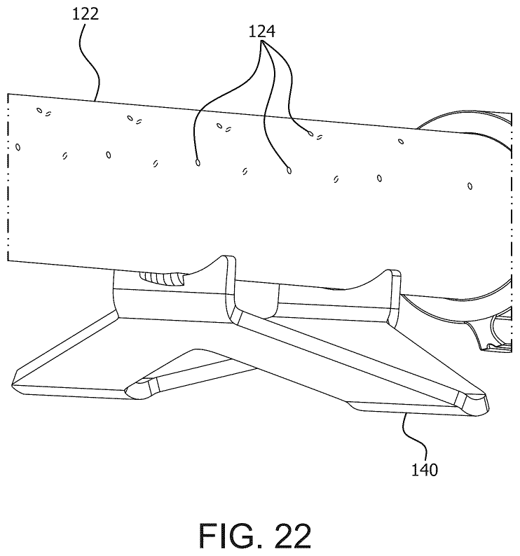

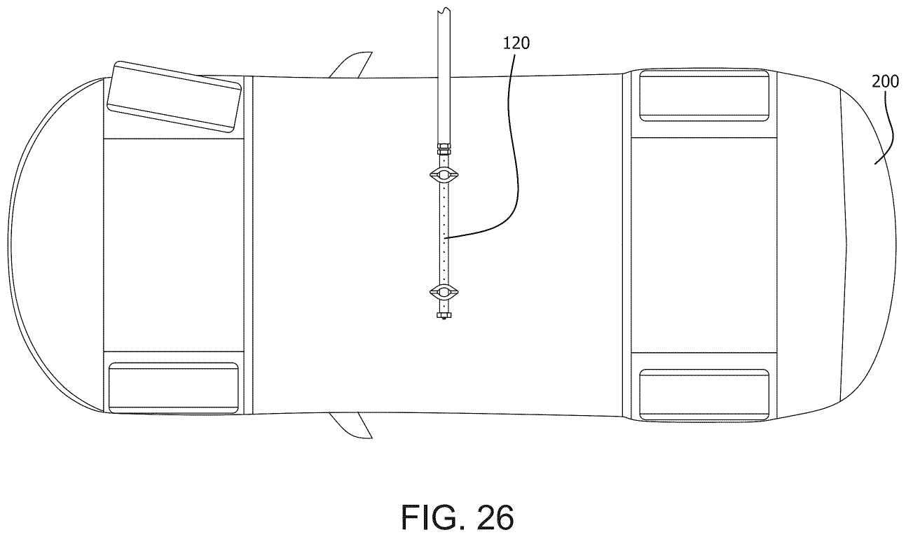

FIGS. 17-27 depict another embodiment in the form of a spray device 120. The spray device 120 is similar to the spray device 50. The above description and discussion of the spray device 50 applies equally to the spray device 120, unless otherwise indicated below.

The spray device 120 incudes a tubular body 122 having a plurality of holes 124 formed therein as described above in relation to the body 52 of the spray device 50. The body 12 can be formed from a durable, rigid, and heat-resistant material such as aluminum or PVC.

Each body 122 can have a length of, for example, about 38 inches. This particular length can facilitate spray coverage of an area of four feet by eight feet, which represents slightly more than the average size of an EV battery storage area. The body 122 can have a length other than 38 inches in alternative embodiments.

Two or more of the bodies 122 can be connected together to make the overall length of the spray device 120 suitable for a specific application, as shown in FIGS. 17, 18, 20, 24, 25, and 27. In the example shown in the figures, two the of the bodies 122 are connected by way of a quick-connect coupling 126 that engages threads formed on the ends of the bodies 122. The bodies 122 can be connected using other types of couplings in the alternative, including a double female swivel coupling.

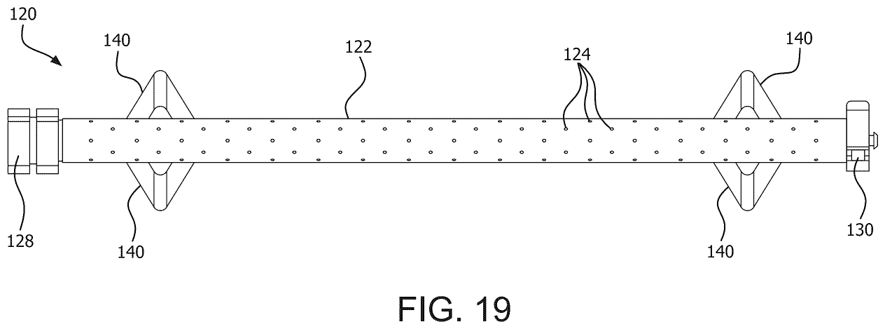

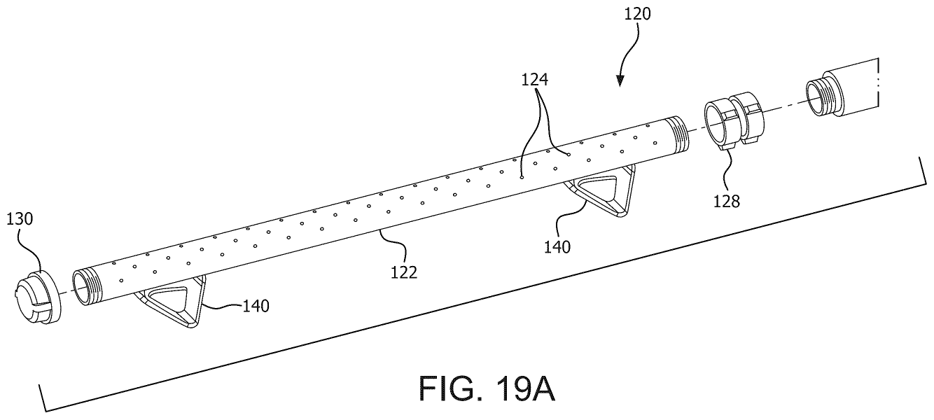

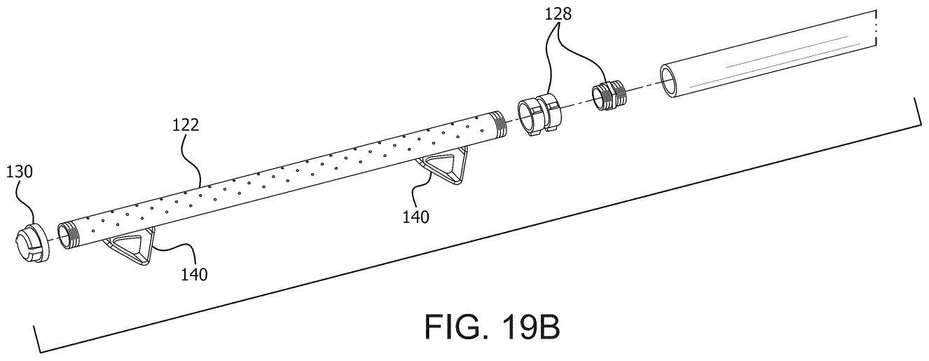

An upstream end of one of the bodies 122 is connected to a coupling or adapter on a hose or other source of water by a quick-connect coupling 128 that engages threads on the upstream end of the body 122 as depicted in FIGS. 17, 19A, and 19B. Other types of couplings, including double female swivel couplings, can be used in lieu of the quick-connect coupling 128 in alternative embodiments. The quick-connect couplings 126, 128 can help facilitate quick assembly and disassembly of the spray device 120, which in turn can permit the spray device 120 to be stored easily, in a relatively compact area. The downstream end of the downstream body 122 is capped and sealed by a cap 130 that engages threads on the downstream end of the body 122.

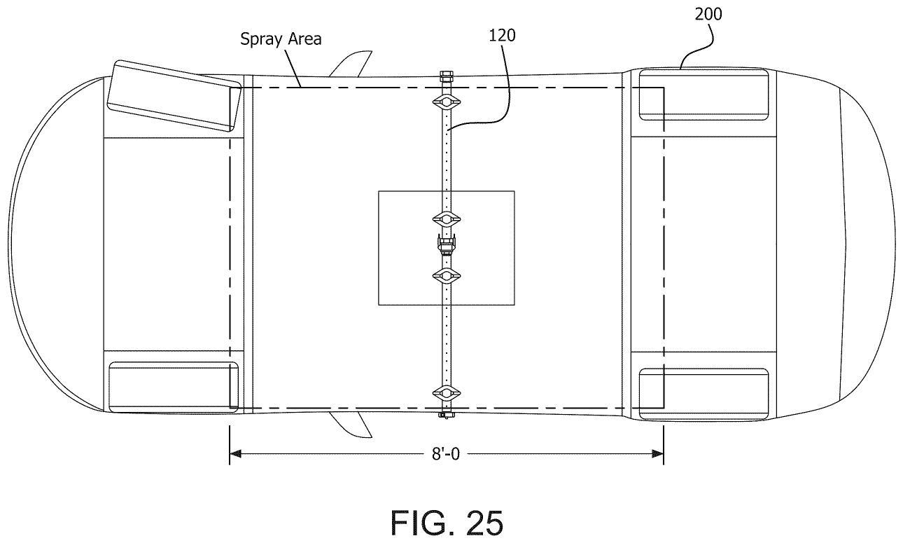

The area of spray coverage of the spray device 120 (depicted diagrammatically in FIG. 25) can be about seven feet by about eight feet when the spray device 120 is configured with two of the bodies 122. Thus, the use of the two bodies 122 can approximately double the lengthwise coverage of the spray pattern generated by the spray device 120.

The body 122 has an inside diameter of about 1.5 inch. Each body 122 can have 83 holes 124 formed therein. Each hole 124 can have a diameter of about 1/16 inch. The relatively small diameter is chosen to increase water velocity within the spray pattern while decreasing the overall water consumption of the spray device 120. The combination of the 1.5-inch-diameter body 122 and the 1/16-inch holes 124 has resulted in a flow velocity through the holes 124 of about 58 feet per second at a pressure of about 60 psi, causing the water be to carried along the bottom of the EV in very specific directions, which in turn can help increase the coverage area of the water spray. The holes 124 can have a diameter greater than or less than 1/16 inch, the body 122 can have an inside diameter greater than or less than 1.5 inch, and/or more or less than 83 holes 124 can be provided in the body 122 in alternative embodiments.

The holes 124 can be spaced by about two inches from the adjacent holes 124 in the same row. The positioning of the holes 124 in adjacent rows can be staggered so that the holes 124 in adjacent rows are not directly adjacent, to help maximize the coverage of the spray pattern generated by the spray device 120. The hole-to-hole spacing can be greater than, or less than one-inch, and/or the positioning of the holes 124 in adjacent rows can be non-staggered in alternative embodiments.

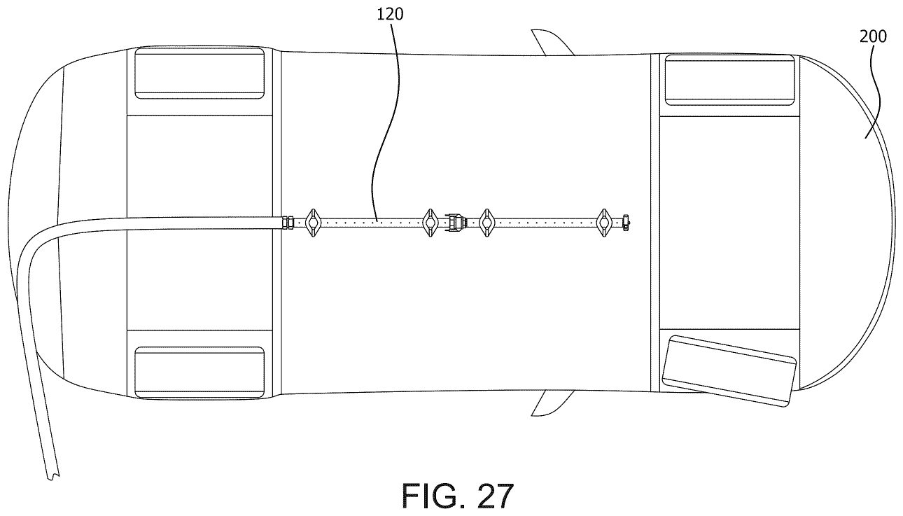

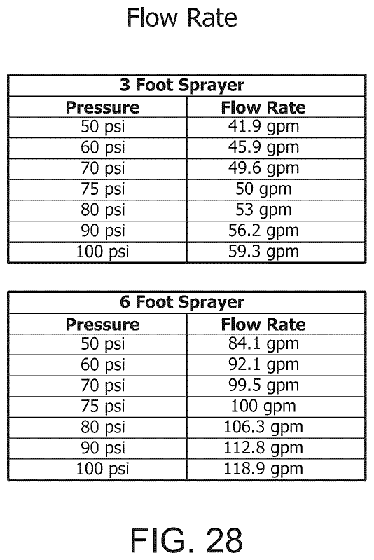

FIG. 28 includes tables depicting the water pressure and the corresponding water flow rate achieved with the 1/16-inch diameter holes 124, for both the single-body configuration and the double-body configuration of the spray device 120. As can be seen in these figures, the water flow rate for the single-tubular-body configuration remained below 60 gallons per minute at all of the noted pressures; and the water flow rate for the double-tubular-body configuration remained below 120 gallons per minute (less than 60 gallons per minute for each body 122) at all of the noted pressures.

The body 122 can be formed from aluminum, to help minimize the weight of the spray device 120 and thereby promote for easier handling of the spray device 120. The body 122 can be anodized to help prevent oxidation of the body 122 from interfering with water flow through the holes 124. The body 122 can be formed from other types of materials in alternative embodiments.

The spray device 120 includes stabilizing feet 140 that help to balance the spray device 120 in an upright position, and inhibit the spray device 120 from “walking” or otherwise moving out of place once it has been positioned, for example, under a vehicle such as the vehicle 200. Two of the feet 140 are connected to each body 122 by welding. The feet 140 can be connected to the body 122 by means other than welding, such as fasteners. Less, or more than two of the feet 140 can be connected to each body 122 in alternative embodiments.

Each foot 140 can be formed a single piece of aluminum. The feet can be formed from materials other than aluminum in alternative embodiments. The aluminum piece can be bent to provide a strong weld surface that can be welded easily to the body 122 during manufacturing. The feet 140 are configured to help give the spray device 120 a relatively low profile, and a minimal overall width and height, to help promote storage in a compact area, and maneuverability.

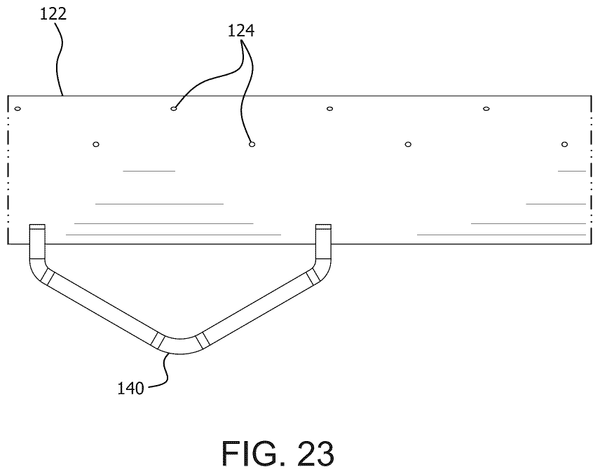

The bottom portion of each foot 140 has an angled configuration with minimum ground contact, to help promote ease of movement of the spray device 120, and enhance the ability to the spray device 120 to slide on uneven and rough surfaces. For example, the bottom portion of the foot 140 can have a substantially v-shaped configuration, with the bottom surface of each side of the foot 140 being angled by about 30 degrees in relation to the horizontal direction as shown in FIG. 23. The feet 140 can have other configurations in the alternative.

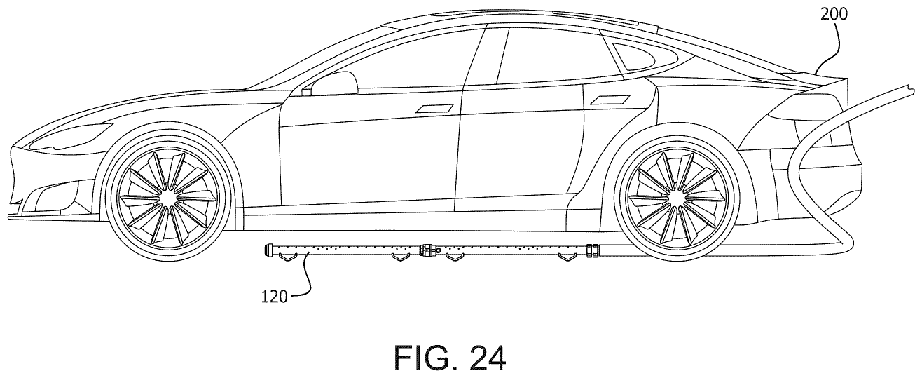

The spray device 120 has an overall height of about 3 11/16 inches, and an overall width of about six inches. The relatively low profile of the spray device 120 permits the spray device 120 to access the space beneath vehicles having a four-inch ground clearance, while still producing an effective upwardly-directed spray pattern. Thus, the spray device 120 can be placed under a low ground clearance vehicle such as the vehicle 200, as shown in FIG. 24, and can be used in a manner similar to the spray device 50 to direct and disperse water at the underside of the vehicle 200 as discussed above in relation to the spray device 50. Alternative embodiments of the spray device 120 can have a height and a width greater than, or less than the above-noted values.

As can be seen in FIGS. 24-27, the spray device 120 can be placed under the vehicle 200 so that the spray device extends in the lengthwise direction of the vehicle 200, the transverse direction of the vehicle 200, or other directions.

The spray devices 10, 50, 80, 120 can be used in applications other than extinguishing battery fires and cooling the batteries of electric vehicles. For example, up five of the spray devices 80 or the spray devices 120 can be coupled in the above-noted manner to produce a water spray about 25-feet high and about 50-feet wide from a water flow-rate as low as about 40 gallons per minute. Also, the spray the devices 10, 50, 80, 120 can be used in connection with vehicles and other objects, including non-moving objects, other that low ground clearance vehicles.

FIG. 29 depicts an extension piece 150 that can be used with the spray devices 50, 80, 120. The extension piece 150 can be used, for example, to help position the spray devices 50, 80, 120 at an optimum or otherwise desired position beneath a vehicle such as the vehicle 200. The extension piece 150 can be coupled to a water supply hose by way of a quick-connect coupling 152 that engages threads on the upstream end of the extension piece 150. The extension piece 150 can be connected to the upstream end of the bodies 52, 82, 122 of the respective spray devices 50, 80, 120 by way of a threaded coupling or other suitable device that engages threads on the downstream end of the extension piece 150. The extension piece 150 does not have any spray holes formed therein, so that all of the water supplied to the extension piece 150 flows to the attached body 52, 82, 122. The extension piece 150 can have an inner diameter of, for example, about 1.5-inch; and a length of, for example, about 18 inches.

FIG. 30 depicts the extension device 150 with a double female swivel coupling 154 that can be used in lieu of the quick-connect coupling 152 to couple the upstream end of the extension device to the water supply hose.

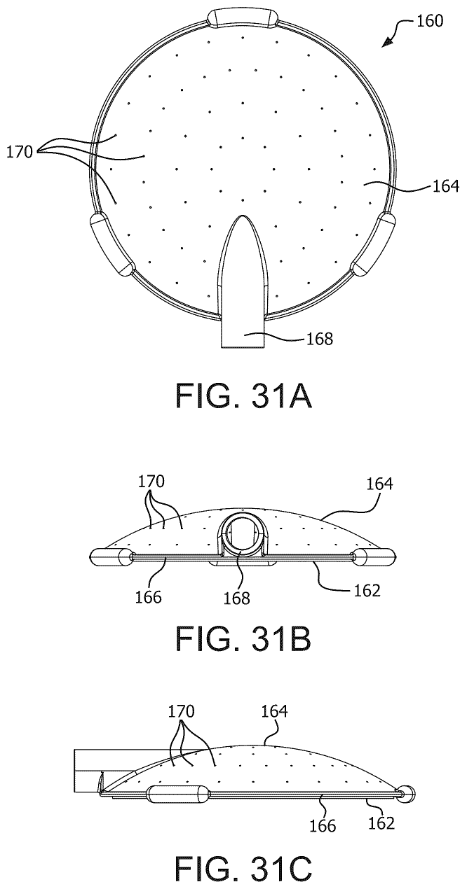

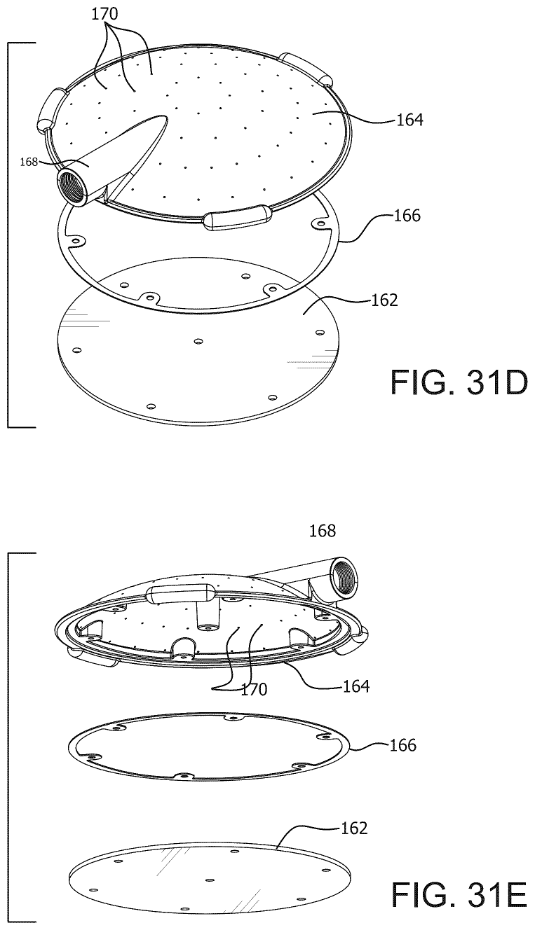

FIGS. 31A-31E depict an alternative embodiment of the spray device 10 in the form of a spray device 160. The spray device 160 includes a base 162, an upper member 164, and a gasket 166. The upper member 164 has a domed configuration, and can be formed, for example, from cast aluminum.

The upper member 164 can be positioned on, and fastened to the base 162. The upper member 164 and the base 162 define an interior volume of the spray device 160. The gasket 166 is located between the upper member 164 and the base 162, and seals the interior volume. A fitting 168, similar to the fitting 32 of the spray device 10, can be integrally formed with the upper member 164. The fitting 168 is configured to engage a coupling or adapter on a hose or other type of water supply, so that water can be supplied to the interior volume of the spray device 160 by way of the fitting 168.

The upper member 164 has a plurality of holes 170 formed therein in a manner similar to the holes 34 in the membrane 16 of the spray device 10. The spray device 160 thus can direct water from within the internal volume in an upward and outward direction, as discussed above in relation to the spray device 10.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

We claim:

1. A spray device, comprising:
a tubular body defining an interior volume, the body having a plurality of holes formed therein and adjoining the interior volume, the holes being located along not more than an upper half of the body;
at least one foot connected to the body and configured to maintain the body in an upright orientation; and
a coupling mounted on an upstream end of the body and in fluid communication with the interior volume of the body, the coupling being configured to be fluidly coupled to a source of water;
wherein the body is configured so that the water supplied to the body by way of the coupling can exit the spray device by way of the holes in an upward and outward direction.

2. The spray device of claim 1, wherein:
the body is a first body;
the spray device further comprises a second body; and
the second body is configured to be connected to, and fluidly coupled to the first body to increase an overall length of the spray device.

3. The spray device of claim 2, wherein:
the coupling is a first coupling;
the spray device further comprises a second coupling; and
the second coupling is configured to mechanically connect the first body to the second body.

4. The spray device of claim 1, wherein a downstream end of the body is sealed.

5. The spray device of claim 4, wherein the downstream end of the body is flattened.

6. The spray device of claim 5, further comprising a resilient material located within the downstream end of the body, wherein the resilient material is configured to be compressed by the downstream end of the body to thereby seal the downstream end of the body.

7. The spray device of claim 5, further comprising an end cap configured to be positioned on the downstream end of the body to thereby seal the downstream end of the body.

8. The spray device of claim 1, wherein a maximum height of the spray device is no greater than about 5.5 inches.

9. The spray device of claim 8, wherein the maximum height of the spray device is no greater than about 4.0 inches.

10. The spray device of claim 9, wherein the maximum height of the spray device is no greater than about 3.0 inches.

11. The spray device of claim 10, wherein the maximum height of the spray device is no greater than about 2.0 inches.

12. The spray device of claim 1, wherein the spray device has a length of about 37 inches.

13. The spray device of claim 1, wherein each of the holes has a diameter of about 1/16-inch.

14. The spray device of claim 1, wherein the body has an inside diameter of about 1.5 inch.

15. The spray device of claim 1, wherein the at least one foot has a substantially V-shaped configuration.

16. The spray device of claim 1, wherein the body is rigid.

17. A method of spraying water on an underside of a vehicle, comprising:
Providing a spray device comprising:
a tubular body defining an interior volume, the body having a plurality of holes formed therein and adjoining the interior volume, the holes being located along not more than an upper half of the body;
at least one foot connected to the body and configured to maintain the body in an upright orientation; and
a coupling mounted on an upstream end of the body and in fluid communication with the interior volume of the body;
placing the spray device underneath the vehicle; and
fluidly coupling the coupling to a source of water so that the water supplied to the body by way of the coupling can exit the spray device by way of the holes in an upward and outward direction toward the underside of the vehicle.

18. The method of claim 17, wherein placing the spray device underneath the vehicle comprises placing the spray device underneath the vehicle so that the at least one foot rests on the ground at least some of the holes in the body face the underside of the vehicle.

19. The method of claim 17, wherein:
the body is a first body and the coupling is a first coupling; and
the method further comprises mechanically connecting the first body to the second body by way of the second coupling.

20. A spray device, comprising:
a base;
a plate member mounted on the base;
a coupling configured to be fluidly coupled to a source of water; and
a membrane retained by the plate member and the base and comprising an upwardly-facing, dome-shaped portion having a plurality of holes formed therein, wherein the membrane and the base define an interior volume in fluid communication with the coupling and the holes so that the water supplied to the coupling can exit the spray device by way of the holes in an upward and outward direction.
